(19) United States
(12) Patent Application Publication
(10) Pub. No.: US 2003/0159025 A1
(43) Pub. Date: Aug. 21, 2003

(54) Run-time compression/decompression of a boot image

(75) Inventor: Scott P. Dubal, Beaverton, OR (US)

Correspondence Address: Schwegman, Lundberg,, Woessner & Kluth, P.A., P.O. Box 2938, Minneapolis, MN, 55402, US

(73) Assignee: Intel Corporation

(21) Appl. No.: 10/078,723

(22) Filed: Feb. 19, 2002

(51) Int. Cl. G06F 15/177

(52) U.S. Cl. 713/1

(57) ABSTRACT

A method, apparatus, and signal-bearing medium for compressing a boot ROM image into a network adapter's boot ROM and then decompressing the boot ROM image into the memory of an electronic device before executing it. In addition to the compressed boot ROM image, the boot ROM may also contain a decompressor for decompressing the boot ROM image and a loader for loading the decompressor.

### FIELD

This invention relates generally to network adapters and more particularly to the run-time compression and decompression of a boot image for a network adapter.

### BACKGROUND

People increasingly use networks of computers because they wish to access and share information. As one example, companies often have computers used by their employees connected together in a network. These networked computers and the software that run on them are rarely identical and often have disparate configurations. For example, a mailroom employee might need a scanner to scan incoming mail into the network while the marketing manager might have no need for a scanner, but does need Internet access to communicate with customers. As the number of networked computers and disparate configurations expands, it becomes increasing difficult for the IT (Information Technology) department to keep track of and manage the different hardware and software configurations.

IT departments have attempted to address this problem by connecting client computers to a server computer via a network and downloading appropriate software and configuration parameters from the server to network adapters in the various client computers. This software and configuration parameters are often called a boot binary image and are used to boot up or load the client computer from a boot ROM (Read Only Memory) in the network adapter.

Currently, the size of a network adapter's boot ROM limits how large of a boot image can be stored in the network adapter. But, the size of the boot ROM image increases as improvements are made, functions are added, and bugs are fixed. As the size of the boot ROM image increases, the manufacturer of the network adapter must increase the size of the boot ROM. This increase in the size of the boot ROM also increases the cost of the network adapter since larger ROMs cost more money.

### BRIEF DESCRIPTION OF THE DRAWINGS

FIG. 1 depicts a block diagram of a electronic device for implementing an embodiment of the invention.

FIG. 2 depicts a flowchart of example processing for a utility program that compresses a boot ROM image into a boot ROM, according to an embodiment of the invention.

FIG. 3 depicts a flowchart of example processing for decompressing, loading, and running the compressed boot ROM image, according to an embodiment of the invention.

FIG. 4 depicts a block diagram of a boot ROM header data structure, according to an embodiment of the invention.

### DETAILED DESCRIPTION

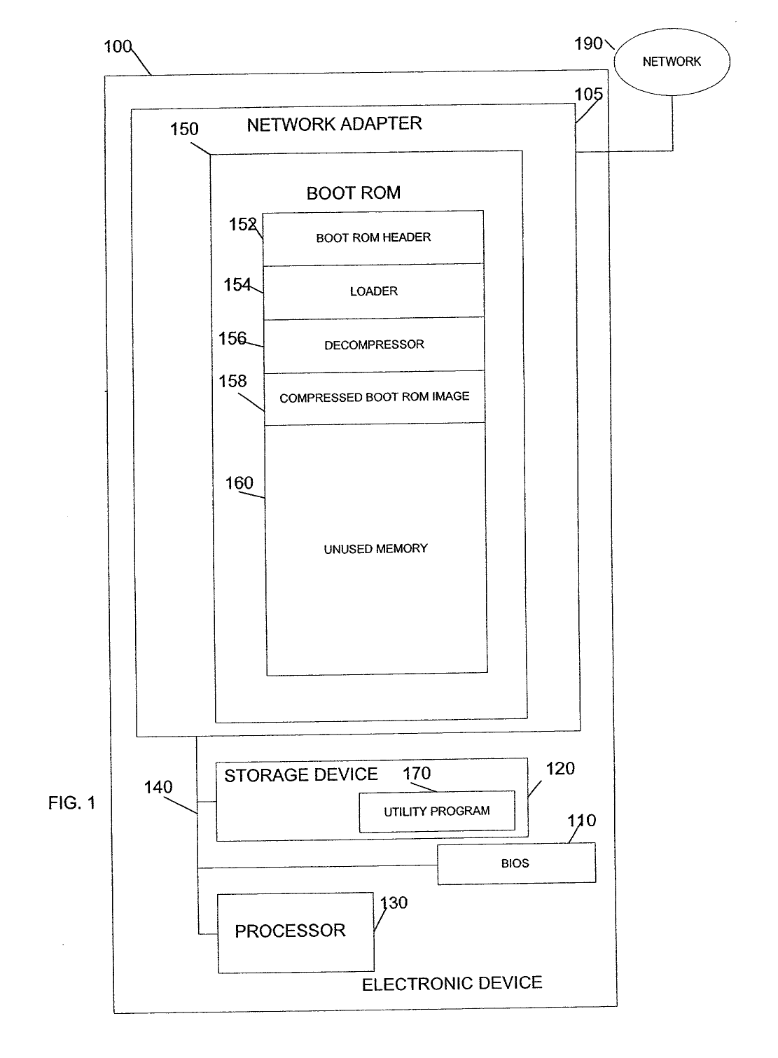

FIG. 1 depicts a block diagram of an electronic device 100 connected to a network 190 for implementing an embodiment of the invention. An electronic device 100 may include a network adapter 105, a BIOS (Basic Input/Output System) 110, a storage device 120, and a processor 130, all connected via a bus 140.

The network adapter 105 may facilitate communication between the electronic device 100 and the network 190. Although network adapter 105 is shown as part of the electronic device 100, in another embodiment they may be packaged separately. Although only one network adapter 105 is shown, in other embodiments, multiple network adapters of the same or of a variety of types may be present.

The network adapter 105 may include a boot ROM 150, which may include a boot ROM header 152, a boot ROM loader 154, a decompressor 156, a compressed boot ROM image 158, and unused memory 160. The network adapter 105 may include other elements not necessary to understanding the invention.

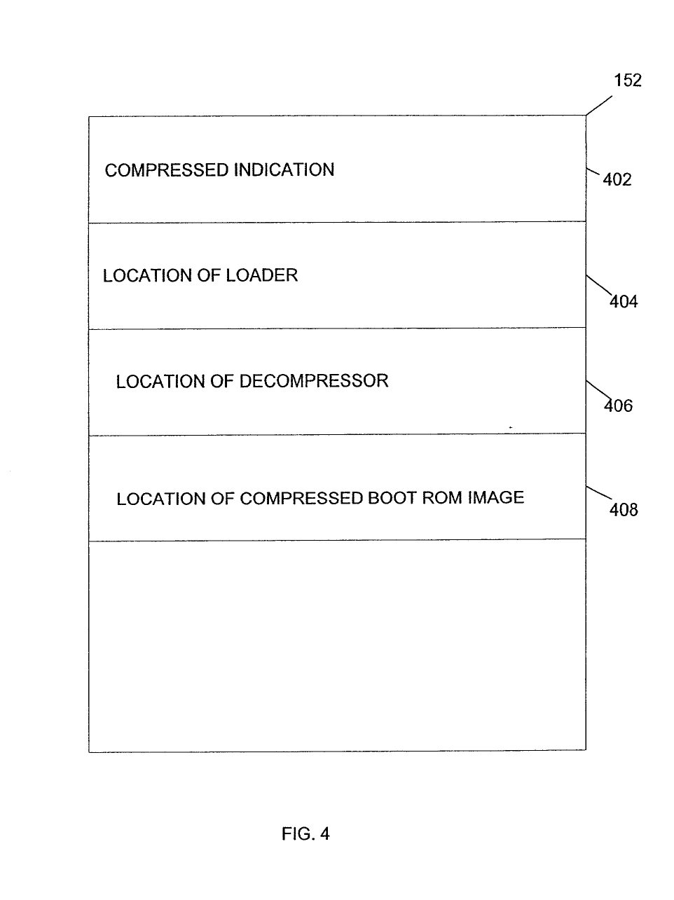

The boot ROM header 152 may include pointers, offsets, addresses, and/or other means of finding the boot ROM loader 154, the decompressor 156, and the compressed boot ROM image 158 within boot rom boot ROM 150. The boot ROM header 152 also may include an indication that the boot ROM image 158 is compressed and needs to be decompressed before being executed. The boot ROM header 152 is further described below with reference to FIG. 4.

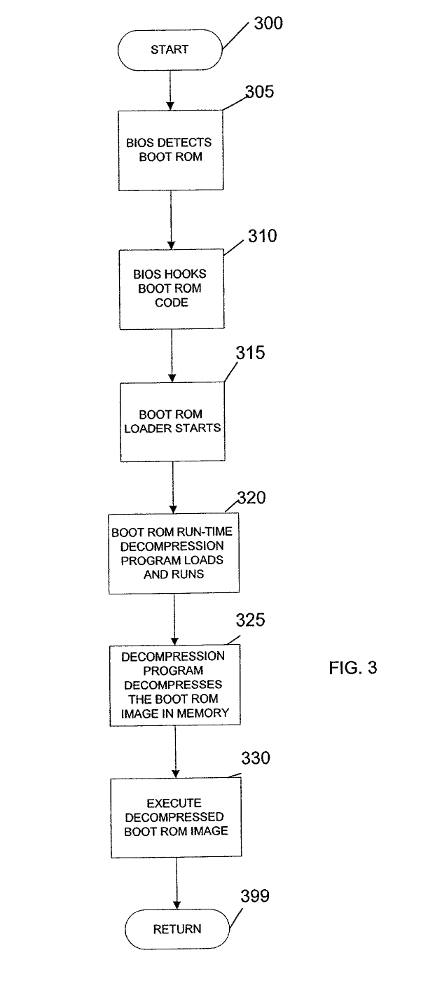

Referring again to FIG. 1, the boot ROM loader 154 may load the decompressor program 156 into the storage device 120 for execution. In an embodiment, the boot ROM loader 154 may be a UNDI (Universal Network Driver Interface) loader, but in another embodiment, any appropriate loader may be used. The functions of the boot ROM loader 154 are further described below with reference to FIG. 3.

Referring again to FIG. 1, the decompressor 156 may decompress the compressed boot ROM image 158. The functions of the decompressor 156 are further described below with reference to FIG. 3.

Referring again to FIG. 1, the compressed boot ROM image 158 may contain a compressed form of the boot ROM image. In an embodiment, the boot ROM image may be a PXE (Preboot Execution Environment) image. But, in another embodiment, any boot ROM image specification may be used. In an embodiment, the boot ROM image that is compressed into the compressed boot ROM image 158 may be obtained by the network adapter 105 from across the network 190, but in another embodiment the boot ROM image may be obtained from any suitable source.

The unused memory 160 represents available memory locations in the boot ROM 150. The unused memory 160 may be available because the combined size of the boot ROM header 152, the boot ROM loader 154, the decompressor 156, and the compressed boot ROM image 158 are less than the size of the boot ROM 150. In another embodiment, the unused memory 160 may not exist because the boot ROM 150 is completely filled.

The BIOS 110 may include programs for basic input and output operations in the electronic device 100 and may provide functions for accessing the network adapter 105 and the storage device 120. In another embodiment, the BIOS 110 may include functions for accessing other peripheral devices (not shown) such as a graphics adapter, keyboard, pointing device, or other type of device. In an embodiment, the BIOS 110 may include instructions stored in RAM (Random Access Memory) and executed on the processor 130. Although the BIOS 110 is drawn as being separate from the storage device 120, in another embodiment, the BIOS 110 may be part of the storage device 120.

The storage device 120 may represent one or more mechanisms for storing data. For example, the storage device 120 may include read only memory (ROM), random access memory (RAM), magnetic disk storage media, optical storage media, flash memory devices, and/or other machine-readable media. In other embodiments, any appropriate type of storage device may be used. Although only one storage device 120 is shown, multiple storage devices and multiple types of storage devices may be present. Further, although the electronic device 100 is drawn to contain the storage device 120, it may be distributed across other electronic devices.

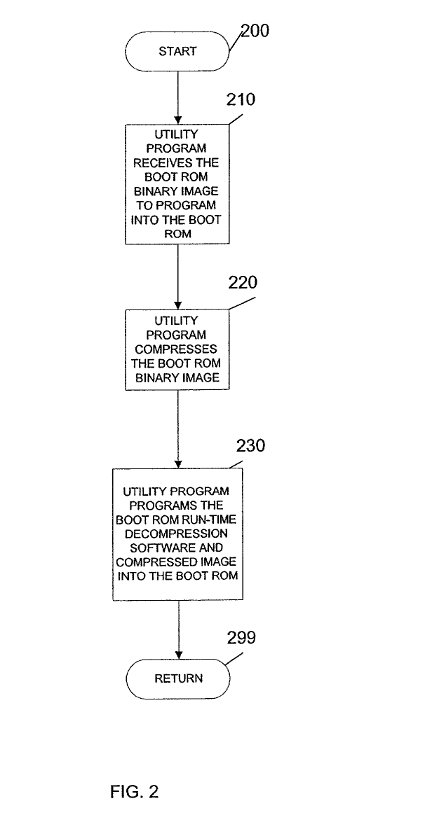

The storage device 120 may include a utility program 170. The utility program 170 may include instructions that are capable of executing on the processor 130 to compress a boot image, among other possible functions. In an embodiment, the utility program 170 may use a Lempel-Ziv-Welch (LZW) compression algorithm. In another embodiment, the utility program 170 may use a Prediction by Partial Match (PPM) compression algorithm. In another embodiment the utility program 170 may use an Adaptive Huffman Coding compression algorithm. In another embodiment, the utility program 170 may use any appropriate compression algorithm. The operations of the utility program 170 are further described below with reference to FIG. 2. Of course, the storage device 120 may also contain additional software and data (not shown), which are not necessary to understanding the invention.

The processor 130 may represent a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 130 may execute instructions and may include that portion of the electronic device 100 that controls the operation of the entire electronic device. Although not depicted in FIG. 1, the processor 130 typically includes a control unit that organizes data and program storage in memory and transfers data and other information between the various parts of the electronic device 100.

The bus 140 may represent one or more busses, e.g., PCI, ISA (Industry Standard Architecture), X-Bus, EISA (Extended Industry Standard Architecture), or any other appropriate bus and/or bridge (also called a bus controller).

Although the electronic device 100 is shown to contain only a single processor 130 and a single bus 140, the present invention applies equally to electronic devices that may have multiple processors and to electronic devices that may have multiple buses with some or all performing different functions in different ways.

The electronic device 100 may be implemented using any suitable hardware and/or software, such as a personal computer or other appropriate electronic device. Portable electronic devices, laptop or notebook computers, PDAs (Personal Digital Assistants), two-way alphanumeric pagers, portable telephones, pocket computers, network appliances, minicomputers, and mainframe computers are examples of other possible configurations of the electronic device 100.

The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted. Thus, an embodiment of the invention may apply to any hardware configuration that compresses and/or decompresses a boot image.

The network 190 may be any suitable network and may support any appropriate protocol suitable for communication to the network adapter 105 of the electronic device 100. In an embodiment, the network 190 may support wireless communications. In another embodiment, the network 190 may support hard-wired communications, such as a telephone line or cable. In another embodiment, the network 190 may support the Ethernet IEEE 802.3x specification. In another embodiment, the network 190 may support the Ethernet Gigabit IEEE 802.3z specification. In another embodiment, the network 190 may be the Internet and may support IP (Internet Protocol). In another embodiment, the network 190 may be a local area network (LAN) or a wide area network (WAN). In another embodiment, the network 190 may be a hotspot service provider network. In another embodiment, the network 190 may be an intranet. In another embodiment, the network 190 may be a GPRS (General Packet Radio Service) network. In another embodiment, the network 190 may be any appropriate cellular data network or cell-based radio network technology. In another embodiment, the network 190 may be a version of the IEEE (Institute of Electrical and Electronics Engineers) 802.11 wireless network. In another embodiment, the network 190 may be a storage area network. In still another embodiment, the network 190 may be any suitable network or combination of networks. Although one network 190 is shown, in other embodiments any number of networks (of the same or different types) may be present.

As will be described in detail below, aspects of an embodiment pertain to specific apparatus and method elements implementable on an electronic device. In another embodiment, the invention may be implemented as a program product for use with an electronic device. The programs defining the functions of this embodiment may be delivered to an electronic device via a variety of signal-bearing media, which include, but are not limited to:

(1) information permanently stored on a non-rewriteable storage medium (e.g., read-only memory devices attached to or within an electronic device, such as a CD-ROM readable by a CD-ROM drive);

(2) alterable information stored on a rewriteable storage medium (e.g., a hard disk drive or diskette); or

(3) information conveyed to an electronic device by a communications medium, such as through a electronic device or a telephone network accessed via a network, including wireless communications.

Such signal-bearing media, when carrying machine-readable instructions that direct the functions of the present invention, represent embodiments of the present invention.

FIG. 2 depicts a flowchart of example processing for compressing, according to an embodiment of the invention. Control begins at block 200. Control then continues to block 210 where the utility program 170 receives the boot ROM binary image to program into the boot ROM 150. The utility program 170 may receive the boot ROM binary image from the network 190 or from any other appropriate source. Control then continues to block 220 where the utility program 170 compresses the boot ROM binary image that was previously received at block 210. The utility program 170 may use any appropriate compression technology, as previously described above.

Control then continues to block 230 where the utility program 170 creates the boot ROM header 152 and programs the boot ROM header 152, the boot ROM loader 154, the decompressor 156, and the compressed boot ROM image 158 into the boot ROM 150. The contents of the boot ROM header 152 are further described below with reference to FIG. 4. The actions and purpose of the boot ROM loader 154, the decompressor 156, and the compressed boot ROM image 158 are further described below with reference to FIG. 3. Referring again to FIG. 2, control then continues to block 299 where the function returns.

FIG. 3 depicts a flowchart of example processing for decompressing, loading, and running the compressed boot ROM image 158, according to an embodiment of the invention.

Control begins at block 300. Control then continues to block 305 where the BIOS 110 detects the presence of the boot ROM 150 within the network adapter 105.

Control then continues to block 310 where the BIOS 110 hooks the compressed boot ROM image 158 using the boot ROM header 152 to find the boot ROM loader 154, the decompressor 156, and the compressed boot ROM image 158. The BIOS 110 also determines that the compressed boot ROM image 158 is compressed using the ROM header 152.

Control then continues to block 315 where the boot ROM loader 154 starts executing on the processor 130. In another embodiment, the boot ROM loader 154 starts executing on a processor (not shown) within the network adapter 105. Control then continues to block 320 where the boot ROM loader 154 loads the decompressor 156 and the decompressor 156 begins executing on the processor 130. In another embodiment, the decompressor 156 begins executing on a processor (not shown) within the network adapter 105.

Control then continues to block 325 where the decompressor 156 decompresses the compressed boot ROM image 158 into the storage device 120. Control then continues to block 330 where the decompressed boot ROM image executes on the processor 130 to boot the electronic device 100.

Control then continues to block 399 where the function returns.

FIG. 4 depicts a block diagram of a data structure for the boot ROM header 152. The boot ROM header 152 may include a compressed indication field 402, a location of the loader field 404, a location of the decompressor field 406, and a location of the compressed boot ROM image field 408. The data structure for the boot ROM header 152 may also contain other fields not necessary to understanding the invention.

The compressed indication field 402 may include an indication of whether the boot ROM image 158 is compressed and needs to be decompressed before being executed.

The location of the loader field 404 may include an indication of the location of the boot ROM loader 154 within the boot ROM 150.

The location of the decompressor field 406 may include an indication of the location of the decompressor 156 within the boot ROM 150.

The location of the compressed boot ROM image field 408 may include an indication of the location of the compressed boot ROM image 158 within the boot ROM 150.

The location of the loader field 404, the location of the decompressor field 406, and the location of the compressed boot ROM image field 408 may include pointers, offsets, addresses, or other locating means. They may include the same type of locating means or different types of locating means.

In the previous detailed description of exemplary embodiments of the invention, reference was made to the accompanying drawings (where like numbers represent like elements), which form a part hereof, and in which was shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. The previous detailed description is, therefore, not to be taken in a limiting sense, and the scope of the present invention is defined only by the appended claims.

Numerous specific details were set forth to provide a thorough understanding of the invention. However, the invention may be practiced without these specific details. In other instances, well-known circuits, structures and techniques have not been shown in detail in order not to obscure the invention.

What is claimed is:

1. A method comprising:
receiving a boot image from a server via a network;
creating a compressed boot image from the boot image; and
programming the compressed boot image into a boot ROM of a network adapter.

2. The method of claim 1, further comprising:
programing a loader into the boot ROM.

3. The method of claim 1, further comprising:
programming a decompressor into the boot ROM.

4. The method of claim 2, further comprising:
programming a header into the boot ROM.

5. The method of claim 4, wherein the programming further comprises:
identifying in the header that the boot image is compressed.

6. The method of claim 4, further comprising:
identifying in the header a location of the loader in the boot ROM.

7. A method comprising:
detecting a boot ROM in a network adapter;
finding a loader in the boot ROM;
loading a decompressor via the loader; and
decompressing a boot image from the boot ROM into a decompressed boot image via the decompressor.

8. The method of claim 7, wherein finding the loader further comprises:
finding the loader via a header in the boot ROM.

9. The method of claim 7, wherein loading the decompressor further comprises:
finding the decompressor via a header in the boot ROM.

10. The method of claim 7, further comprising:
determining that the boot image is compressed using a header in the boot ROM.

11. The method of claim 7, further comprising:
finding the boot image using a header in the boot ROM.

12. The method of claim 7, further comprising:
executing the decompressed boot image to boot an electronic device.

13. A signal-bearing medium bearing instructions, which when read and executed comprise:
detecting a boot ROM in a network adapter;
finding a loader via a header in the boot ROM;
finding a decompressor via the header;
finding a first binary image via the header; and
decompressing the first binary image into an second binary image in memory of an electronic device.

14. The signal-bearing medium of claim 13, wherein the instructions further comprise:
executing the second binary image to boot the electronic device.

15. The signal-bearing medium of claim 13, wherein the instructions further comprise:
loading the decompressor via the loader.

16. The signal-bearing medium of claim 13, wherein the instructions further comprise
determining that the first binary image is compressed via the header.

17. A network adapter comprising:
a boot ROM including:
a boot image;
a decompressor to decompress the boot image;
a loader to load the decompressor; and
a header to indicate a location of the boot image.

18. The network adapter of claim 17 wherein the header is further to indicate a location of the loader.

19. The network adapter of claim 17, wherein the header is further to indicate a location of the decompressor.

20. The network adapter of claim 17, wherein the boot image when decompressed is to boot an electronic device.

21. An electronic device comprising:
a processor;
a network adapter comprising a boot ROM; and
a storage device comprising a utility program that when executed on the processor is to compress a boot image into a compressed boot image and program the compressed boot image into the boot ROM.

22. The electronic device of claim 21, wherein the utility program is further to program a loader and decompressor into the boot ROM.

23. The electronic device of claim 21, wherein the boot image is further to boot an electronic device.

24. The electronic device of claim 21 further comprising:
a BIOS to detect the boot ROM.
